(19) United States
(12) Patent Application Publication
(10) Pub. No.: US 2007/0055714 A1
(43) Pub. Date: Mar. 8, 2007

(54) Migration system for confirming worm retention term

(76) Inventors: Yohsuke Ishii, Yokohama (JP); Hironori Tsuji, Fujisawa (JP); Yoji Nakatani, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/256,944

(22) Filed: Oct. 25, 2005

(30) Foreign Application Priority Data
Sep. 6, 2005 (JP) 2005-257987

(51) Int. Cl. G06F 17/30

(52) U.S. Cl. 707/204

(57) ABSTRACT

Provided is a computer system, which executes migration after confirming that a retention term of an information resource stored in the computer system can be guaranteed at a migration destination. In a storage system including a control module, a disk drive for storing data, and a time information module for managing time information including a time, the control module obtains first time information from another storage system connected via a network, obtains second time information from the time information module, calculates a difference value between the first time information and the second time information, and in the case where the calculated difference value is smaller than a predetermined threshold, moves the data stored in the disk drive to another storage system.

### CLAIM OF PRIORITY

The present application claims priority from Japanese application P2005-257987 filed on Sep. 6, 2005, the content of which is hereby incorporated by reference into this application.

### BACKGROUND

This invention relates to migration control for an information resource stored in a computer system.

Conventional computer systems are provided with a method of migrating an information resource stored in a casing used for operating the system to another casing in the course of the operation of the information resource, and continuing the operation using the information resource at a migration destination. This process is called a migration. A method for the migration is essential to the exchange of devices involved in the update of the computer system. When the information resource is migrated to another casing, the consistency of processing at a time of the operation of the information resource needs to be guaranteed even at the migration destination. For this purpose, it is necessary to guarantee the consistency of clock information between the migration source and the migration destination.

As a mechanism for guaranteeing the consistency of the clock information, the following technique is disclosed in, for example, US 2004/0128549. According to the technique, a computer system is capable of detection of unauthorized tampering processing performed against a system clock used by the system for obtaining clock information is detected, thereby suppressing the processing of impairing the consistency of the clock information. On the other hand, as data in which the consistency of time information is important, there is data in a write once read many (WORM) format. The data in a WORM format is predicated on a long retention term. In order to guarantee the long retention term, it is essential to migrate an information resource containing data in a WORM format to another casing.

### SUMMARY

In order to migrate data in a WORM format between computer systems, it is necessary to guarantee the consistency of time information between the computer systems. However, US 2004/0128549 that discloses the above technique contains no description that, at a time when an information resource in a computer system is migrated to another casing, clock information at a migration destination guarantees the consistency with the clock information at a migration source.

To guarantee a long retention term, it is essential to migrate an information resource to another casing. More specifically, even in a computer system at a migration destination, the retention term of a WORM resource needs to be guaranteed. Thus, in order to guarantee the long term retention of a WORM resource, when the WORM resource is migrated, a technique of guaranteeing the consistency of clock information between the migration source and the migration destination is essential.

An object of this invention is to provide a migration system capable of guaranteeing the consistency of various attribute information between a migration source and a migration destination when migration is performed between computer systems.

In order to achieve the above-mentioned object, this invention is characterized in that, when an information resource is moved between storage systems, information on a time of another storage system to be a migration destination is corrected, and the information resource is moved.

According to this invention, when a WORM resource is migrated between storage systems, information on a clock of a storage system to be a migration destination is corrected, whereby the consistency of attributes of the information resource can be guaranteed. Consequently, unauthorized tampering and unnecessary deletion caused by a time shift due to the migration of the information resource can be prevented.

### BRIEF DESCRIPTION OF THE DRAWINGS

FIG. 1 is a block diagram showing a configuration of a computer system according to an embodiment of this invention.

FIG. 2 is a block diagram showing a configuration of hardware of a storage system.

FIG. 3 is an explanatory diagram illustrating an example configuration of a migration management table.

FIG. 4 is an explanatory diagram illustrating an example configuration of a clock difference information management table.

FIG. 5 is an explanatory diagram illustrating an example hardware configuration of a management server.

FIG. 6 is an explanatory diagram illustrating an example configuration of attributes of each information resource.

FIG. 7 is an explanatory diagram illustrating an outline of migration processing.

FIG. 8 is a flow chart showing a procedure of migration processing.

FIG. 9 is a flow chart showing a procedure of processing of correcting a clock.

FIG. 10 is a flow chart showing a processing procedure in retention term expiration confirmation processing.

FIG. 11 is a flow chart showing a procedure of migration policy setting processing of an information resource.

FIG. 12 is a flow chart showing a processing procedure in tolerance setting processing for migration of an information resource.

FIG. 13 is an explanatory diagram illustrating an example configuration of a clock difference information management table according to a modified example.

FIG. 14 is a flow chart showing a procedure of migration processing of an information resource according to a modified example.

### DESCRIPTION OF THE PREFERRED EMBODIMENTS

Hereinafter, an embodiment of this invention will be described, with reference to the drawings.

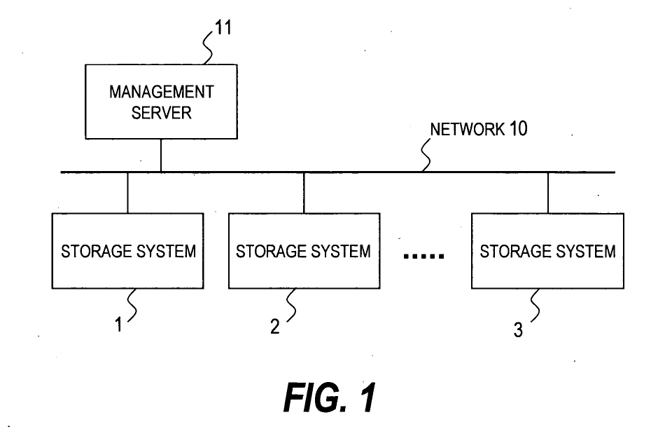

FIG. 1 is a block diagram showing a configuration of a computer system according to an embodiment of this invention.

In the computer system of this embodiment, an information resource such as a WORM data is retained, and the retained information resource can be migrated between storage systems. The migration refers to migrating an information resource to another casing, and continuing the operation using the information resource at a migration destination. The computer system comprises storage systems 1, 2, and 3 and a management server 11. The respective storage systems 1, 2, and 3 and the management server 11 are connected to each other via a network 10. An individual network for connecting only the storage systems 1, 2, and 3 may be separately provided.

The storage systems 1, 2, and 3 store an information resource such as data. The storage system is a computer or a server having a storage for operating an information resource such as data stored in the storage, and can be identified with at least one identifier on the network.

The storage systems 1, 2, and 3 perform a control corresponding to each information resource so as to manage an information resource to be stored. Furthermore, the storage systems 1, 2, and 3 can migrate the respectively stored information resources to other storage systems 1, 2, and 3 in a computer system. Furthermore, the storage systems 1, 2, and 3 perform a setting regarding the WORM of data. Owing to this control, a protected information resource (hereinafter, referred to as a WORM resource) can be provided. Then, the storage systems 1, 2, and 3 can also migrate the WORM resource to other storage systems 1, 2, and 3 in the computer system.

The management server 11 manages the storage systems 1, 2, and 3 of the computer system. In particular, the management server 11 issues a request for setting a migration policy and a request for setting a tolerance value for migration with respect to each information resource to be migrated. The management server 11 may be realized with the same casing as that of the storage systems 1, 2, and 3.

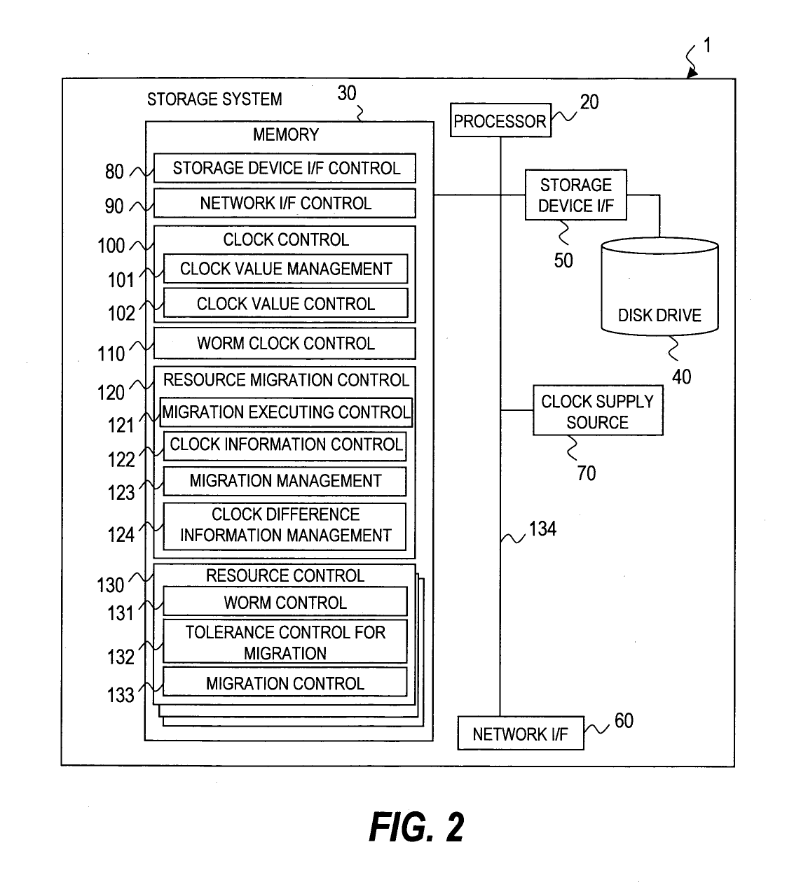

FIG. 2 is a block diagram showing a configuration of hardware of the storage systems 1, 2, and 3.

Herein, although the storage system 1 will be exemplified, the other storage systems 2 and 3 have the same configuration.

The storage system 1 includes a processor 20 executing a program, a memory 30 temporarily storing a program and data, a disk drive 40 capable of permanently storing a program and data, a storage device I/F 50 for accessing the disk drive, a network I/F 60 for accessing other devices connected via the network 10, a clock supply source 70 supplying clock information, and a bus 134 connecting them.

The processor 20 reads a program stored in the memory 30, and executes processing stipulated in the program.

The memory 30 stores a storage device I/F control 80 that is a program controlling the storage device I/F, a network I/F control 90 that is a program controlling the network I/F, a clock control 100 that is a program controlling clock information, a WORM clock control 110 that is a program controlling clock information used for confirming a retention term expiration of a WORM resource, a resource migration control 120 that is a program controlling migration of an information resource, and a resource control 130 that is a program controlling each information resource stored in the storage system.

The clock control 100 contains two programs: a clock value management 101 and a clock value control 102.

The resource migration control 120 contains four programs: a migration executing control 121, a clock information control 122, a migration management 123, and a clock difference information management 124.

The resource control 130 contains three programs: a WORM control 131, a tolerance control for migration 132, and a migration control 133. A plurality of resource controls 130 may be provided.

The network I/F 60 is connected to the network 10 connecting the other storage systems and the management server 11. The storage system 1 communicates with the other storage systems 2 and 3 or the management server 11 by the network I/F control 90 that is a program controlling the network I/F 60. In the case where the computer system is provided with an individual network connecting only the storage systems 1, 2, and 3, the storage system 1 may be provided with an individual network I/F connected to the individual network connecting only the storage systems 1, 2, and 3.

The clock supply source 70 provides clock information with respect to the clock control 100 of the storage system 1. The clock information is capable of recognizing a time, and the contents thereof are not limited. For example, the clock information may provide information to be the standard of increments of a clock, or may provide information on a date and time according to a global standard time. The means for realizing the clock supply source 70 is not limited as long as the clock supply source 70 can provide the clock information. For example, the clock supply source 70 may be a Crystal oscillator or an electric oscillator supplying increments of a clock, or a communicator receiving information on a global standard time from the outside.

The clock control 100 includes a clock value management 101 that is a program storing clock information, and a clock value control 102 that is a program operating the clock information.

The clock value control 102 obtains clock information from the clock supply source 70, and sets the information in the clock value management 101.

The clock value management 101 manages clock information set by the information.

The clock value control 102 periodically updates the clock information managed by the clock value management 101. The clock value control 102 also obtains the clock information. The clock value control 102 also changes the clock information to specified clock information.

The clock value control 102 obtains clock information at a constant interval by the clock supply source 70, and updates the clock information managed by the clock value management 101 after obtaining the clock information, thereby periodically updating the clock information.

The WORM clock control 110 provides WORM clock information. The WORM clock information refers to the clock information used for confirming whether or not the retention term of a WORM resource has expired.

The WORM clock control 110 provides WORM clock information corresponding to the WORM resource by specifying an object WORM resource. More specifically, the WORM clock control 110 obtains the clock information by the clock value control 102 of the clock control 100, obtains clock difference information corresponding to the WORM resource by the clock difference information management 124, and provides a calculated value using the clock information and the clock difference information as WORM clock information.

The resource migration control 120 contains a program controlling the migration processing of an information resource in the storage system 1.

The migration executing control 121 determines whether or not the migration processing to the specified storage systems 1, 2, and 3 is allowed with respect to the specified information resource. Then, the migration executing control 121 requests the resource control 130 of the specified information resource to perform the migration processing of the information resource.

The clock information control 122 obtains clock information of another storage system, and sets the clock information.

The migration management 123 manages information used for performing migration processing of an information resource.

The clock difference information management 124 manages correction information of clock information, in the case where the clock information is migrated between the migration source and the migration destination at a time of migration of an information resource.

The migration executing control 121 determines whether or not the migration processing of an information resource is allowed prior to the migration processing of the information resource. At this time, the migration executing control 121 determines whether or not the migration is allowed based on the information in the migration management table 200 registered in the migration management 123 and the migration tolerance of the information resource. A detailed processing procedure will be described later.

The clock information control 122 obtains clock information in a storage system at a migration destination so as to determine whether or not the migration processing of an information resource is allowed prior to the migration processing of the information resource. Furthermore, the clock information control 122 updates or corrects clock information in the storage system at the migration destination in the case where it is necessary to correct clock information of the storage system at the migration destination when it is determined whether or not the migration processing is allowed. The correction of the clock information is realized by requesting the clock value control 102 or the clock difference information management 124 on the storage system at the migration destination to perform processing via the clock information control 122 on the storage system at the migration destination.

The resource control 130 controls an information resource stored in the storage system 1. More specifically, the resource control 130 includes a volume control for managing a volume, a file system control for managing a file system and a file, and the like, and a program exists independently corresponding to each control. The resource control 130 includes a WORM control 131 performing setting on a WORM with respect to an information resource, a tolerance control for migration 132 managing the tolerance for migration that is a tolerance of a clock shift when an information resource is migrated, and a migration control 133 providing processing of actual migration of the information resource.

The WORM control 131 sets a retention term with respect to the stored information resource, and sets the information resource in a state of a WORM resource. The resource control 130 prevents the tampering and deletion of the WORM resource set in a WORM state, and prevents the cancellation of the WORM state thereof, until the specified retention term expires.

The disk drive 40 stores information managed by the migration management 123 and the clock difference information management 124. The disk drive 40 also stores substantial information of an information resource managed by the resource control 130.

The disk drive 40 comprises one or more disk drives. One or more disk drives constitute a logic volume that is a storage region with a RAID configuration. Information and substantial information of the information resource are stored in the logic volume.

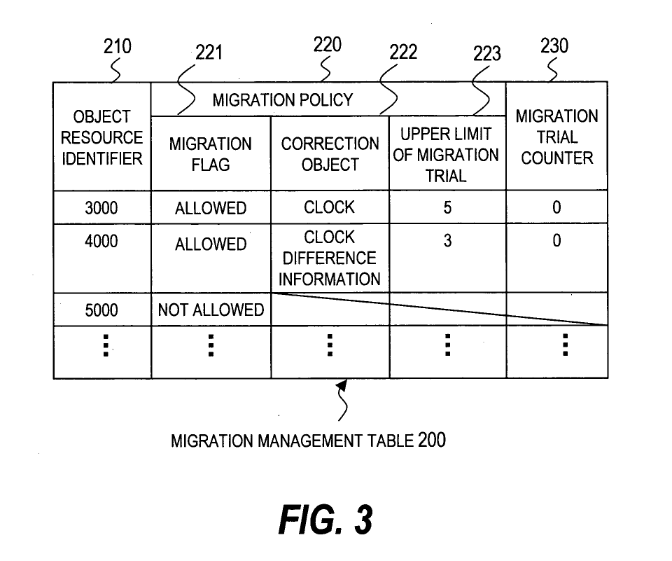

FIG. 3 is an explanatory diagram illustrating an example configuration of the migration management table 200 managed by the migration management 123.

The migration management table 200 includes entries 210, 220, and 230.

An object resource identifier of the entry 210 is identification information of an information resource corresponding to the entry 210, and shows identification information of an information resource to which a migration policy is applied. In the entry 210, a plurality of different kinds of information resources are registered.

The migration policy of the entry 220 is set in the object resource identifier. The migration policy is information for notifying the resource migration control 120 of the storage system 1 whether or not an object information resource can be migrated, whether a correction object is a time or time difference information, or what an upper limit of migration trial is.

The entry 220 further includes entries 221, 222, and 223. Regarding a migration flag of the entry 221, information on whether or not the resource may be migrated is registered. The resource migration control 120 refers to the migration management table 200, and controls so that the information resource that is not allowed for migration is not to be migrated.

Regarding a correction object of the entry 222, the information to be a correction object is registered in the case where it is necessary to correct clock information of the storage system at a migration destination during the migration processing of the information resource. As the information to be a correction object, a clock or clock difference information is registered.

In the case where a “clock” is registered in the correction object of the entry 222, the information of the clock value management 101 of the storage system at the migration destination is corrected. In the case where “clock difference information” is registered, a difference of clock information with respect to the storage system at the migration source is registered as correction information in the clock difference information management 124 of the storage system at the migration destination. In the case where the correction information is registered in the clock difference information management 124, the storage system uses clock information corrected by the WORM clock control 110, based on the information provided by the clock control 100 and the difference information provided by the clock difference information management 124.

As the upper limit of migration trial of the entry 223, an upper limit of the trial number of migration processing of the information resource is registered. In the migration processing, in the case where a shift of clock information between storage systems to be migrated does not satisfy the condition of a tolerance for migration of the information resource, clock information is first corrected, and the processing is further tried. Therefore, the upper limit of the migration trial is used for determining the upper limit of the trial number that also includes a migration retrial.

A migration trial counter of the entry 230 records the trial number of migration processing during the migration processing of the information resource. The migration executing control 121 adds the trial number of migration corresponding to the information resource during the trial or retrial of the migration processing of an information resource. In the case where the migration trial counter of the entry 230 exhibits a value at or above the upper limit of migration trial corresponding to the entry of the information resource, the migration processing of the information resource is ended as an error. When the migration processing of the information resource is ended or ended as an error, the value of the migration trial counter corresponding to the information resource is set to be 0.

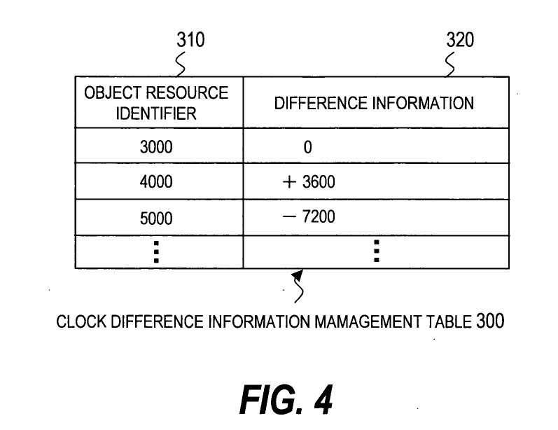

FIG. 4 is an explanatory diagram illustrating an example configuration of a clock difference information management table 300 managed by the clock difference information management 124.

The clock difference information management table 300 includes entries 310 and 320.

An object resource identifier of the entry 310 is an identifier of resource information adopting a migration policy. As the object resource identifier of the entry 310, a plurality of different kinds of information resources are registered.

As difference information of the entry 320, a difference value of clock information between a migration source and a migration destination at a time of migration of the information resource is registered.

The resource migration control 120 refers to the clock information control 122 when correcting a clock in migration processing, and registers a difference value of clock information between the storage systems in the clock difference information management table 300 of the storage system at the migration destination. As the unit of a value registered as the difference value, the one determined for the system is applied. For example, the difference value is assumed to be a second unit. Furthermore, as the meaning of a positive and a negative of a value registered as the difference value, the one determined for the system is applied. For example, a positive value means that the clock information of the storage system proceeds in advance of an original value, and a negative value means that the clock information recedes with respect to the original value.

In the case where a client or the like accesses an information resource of a storage system, in particular, when the client accesses an information resource in which the difference information 320 is registered in the clock difference information management table 300, the WORM clock control 110 corrects clock information using the difference value.

Herein, as shown in FIG. 4, the case will be described where +3600 is set in difference information of an information resource in which the entry 310 is 4000. In the case where clock information is used when the information resource 4000 is dealt with, the WORM clock control 110 corrects so that the clock information obtained from the clock value control 102 of the storage system recedes to the past by a difference value (+3600). A client at an access source uses the corrected clock value. In particular, in the case of dealing with a WORM resource, the correction of clock information is important. A detailed procedure of the correction processing will be described later.

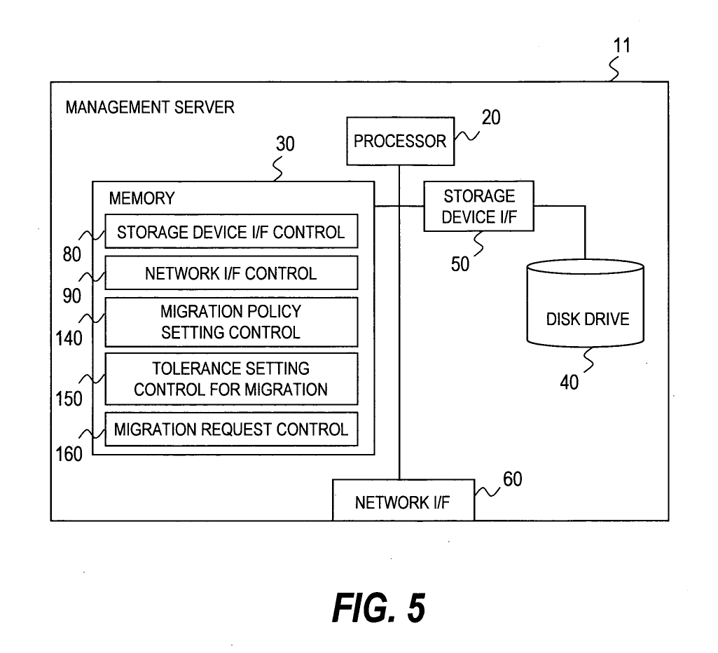

FIG. 5 is an explanatory diagram illustrating an example configuration of hardware of the management server 11.

The management server 11 includes a processor 20 executing a program, a memory 30 temporarily storing a program and data, a disk drive 40 capable of permanently storing a program and data, a storage device I/F 50 for accessing the disk drive, a network I/F 60 for accessing other devices connected to a network, and a bus connecting them.

The processor 20 reads a program stored in the memory 30, and executes the processing stipulated by the program.

The memory 30 stores a storage device I/F control 80 that is a program controlling the storage device I/F, a network I/F control 90 that is a program controlling the network I/F, a migration policy setting control 140 that is a program setting a migration policy in the migration management table 200, a tolerance setting control for migration 150 that is a program setting a tolerance for migration, and a migration request control 160 that is a program requesting the migration executing control 121 to start migration processing.

The above-mentioned migration policy setting control 140, the tolerance setting control for migration 150, and the migration request control 160 may be present in the storage system 1 instead of the management server 11. More specifically, by allowing the storage system 1 to provide these controls, a system that does not include the management server 11 can be configured.

Furthermore, the above-mentioned migration policy setting control 140, the tolerance setting control for migration 150, and the migration request control 160 may be present in management servers 11 separately from each other. More specifically, by allowing the different management servers 11 to provide these controls, a system in which a plurality of management servers 11 are present can be configured.

Furthermore, in the management server 11, the above-mentioned resource migration control 120 may be present. Furthermore, the above-mentioned clock control 100 or the WORM clock control 110 may be present. In the case where these controls are present in the management server 11, it is necessary to access these controls via the network 10 from each resource control present on a storage system.

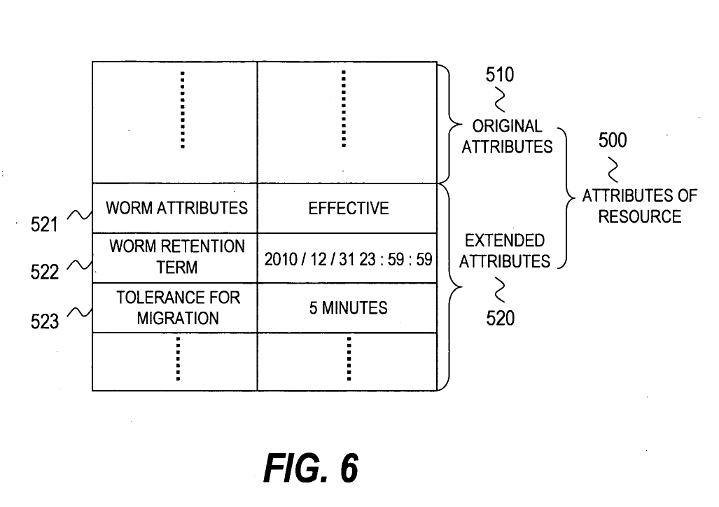

FIG. 6 is an explanatory diagram illustrating an example configuration of attributes 500 of each information resource managed by the resource control 130.

The attributes 500 are stored in the disk drive 40 storing an information resource in association with an information resource. The attributes 500 may be stored in the memory 30 instead of the disk drive 40.

The attributes 500 of an information resource include entries 510 and 520.

The existing attributes of the entry 510 are those of an information resource contained in a conventional computer system, and for example, include an access authority of the information resource, a size of the information resource, and the like.

The extended attributes of the entry 520 further include entries 521, 522, and 523. Attributes other than these may be included in the extended attributes of the entry 520.

In the WORM attributes of the entry 521, information for identifying whether or not the information resource is in a WORM state is set. If the entry 521 is effective, the information resource is in a WORM state.

The resource control 130 suppresses the update and deletion of an information resource in which the WORM attributes of the entry 521 are effective. Furthermore, the resource control 130 suppresses the cancellation of the WORM state during a term designated by the WORM retention term of the entry 522 described later or until the term expires.

As the WORM retention term of the entry 522, a term during which the WORM state of the information resource is effective is set. The information set in the WORM retention term of the entry 522 may be in a form of days or date and time. In the case where the term is set, the WORM attributes of the information resource cannot be invalidated (cancelled) until the term expires. Furthermore, in the case where a term is set, the WORM attributes of the information resource cannot be invalidated until the term expires.

In the case where a term is set, in order to determine whether or not the term expires, it is necessary to separately manage time information at a time to be a base of the term as one element of the WORM retention term of the entry 522.

The resource control 130 permits the extension of the retention term registered in the WORM retention term of the entry 522 as long as the WORM attributes of the entry 521 are effective. However, the resource control 130 does not permit the reduction or deletion of the retention term.

Regarding the toleration for migration of the entry 523, as a condition of permitting migration in the migration processing of the information resource, an upper limit allowable as a difference value of clock information managed by storage systems at a migration source and a migration destination is registered.

The allowable upper limit is previously set, considering the WORM retention term of the information resource, the precision of a clock of a storage system storing the information resource, and the like. For example, in the case where a WORM retention term is set in unit of an hour, a minute, and a second, about several minutes (5 minutes in an example shown in FIG. 6) are set. Furthermore, in the case where a WORM retention term is set in unit of a year, a month, and a date, about several hours or several days are set.

The resource migration control 120 calculates the difference value of clock information between storage systems in migration processing. If the value is equal to or less than the value of tolerance for migration 523, the migration processing is permitted. On the other hand, if the value exceeds the value of the tolerance for migration 523, the migration processing is prohibited.

As a method of managing the attributes 500, the resource control 130 may store the attributes 500 of all the information resources collectively and manage them, or the resource control 130 may store the attributes 500 for each information resource, and manage them individually.

Next, the migration processing of a WORM resource will be described.

In the computer system of this embodiment, when an information resource to be migrated is migrated, first, a migration policy of the information resource to be migrated determines whether or not migration is possible. If the migration is possible, next, the migration policy obtains clock values of a storage system at a migration destination and a storage system at a migration source, and compares them to obtain a difference value. If the difference value is in a tolerance, the information resource to be migrated is migrated, and if the difference value is not in a tolerance, the clock value of the storage system at the migration destination is corrected.

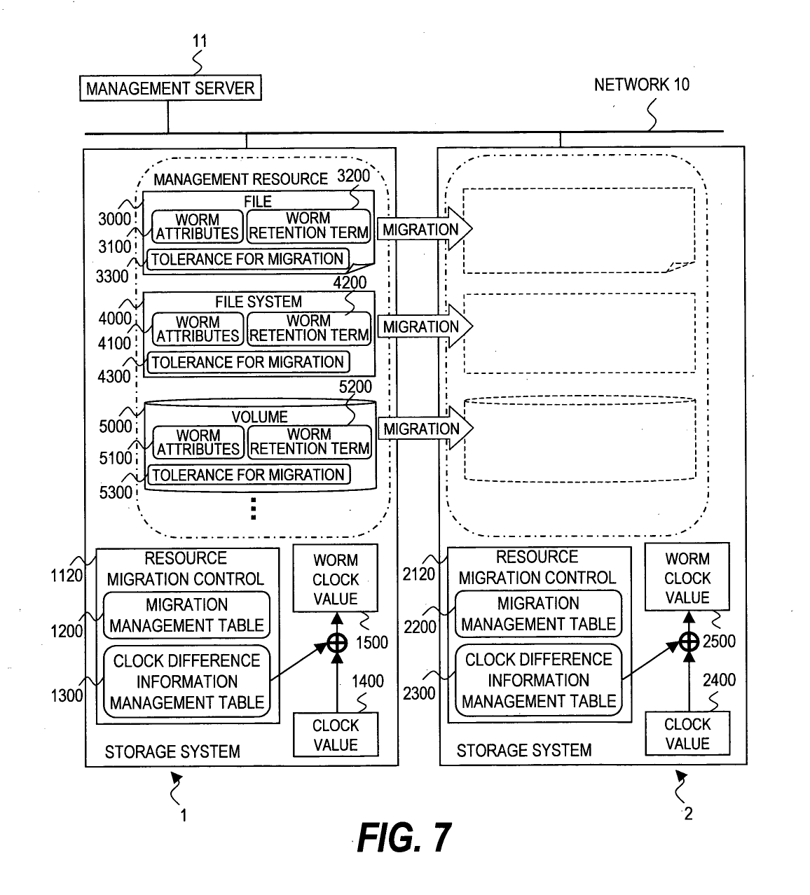

FIG. 7 is an explanatory diagram illustrating an example outline of migration processing of a WORM resource.

As shown in FIG. 1, the computer system of this embodiment includes a storage system 1, a storage system 2, and a management server 11. Hereinafter, in the migration processing of a WORM resource, the processing of migrating a file 3000 present in the storage system 1 to the storage system 2 according to a request from the management server 11 will be described.

In FIG. 7, the storage system 1 manages at least one of the file 3000, a file system 4000, and a volume 5000 as an information resource, and stores it. In each information resource, WORM attributes, a WORM retention term, and a tolerance for migration are set in the entry 520 that is the above-mentioned extended attributes of an information resource. Furthermore, a resource migration control 1120 manages a migration management table 1200 having a configuration shown in FIG. 3 and a clock difference information management table 1300 having a configuration shown in FIG. 4. Furthermore, the storage system 1 uses a WORM clock value 1400 provided by the clock control 100 and a WORM clock value 1500 provided by the WORM clock control 110, and obtains a clock value corresponding to the WORM resource.

Herein, in the storage system 1, the processing of a migration operation with respect to the file 3000 will be described. When the processing is executed, in the case where clock information is required, the WORM clock value 1500 provided by the WORM clock control 110 is used. In this case, the WORM clock control 110 calculates the WORM clock value 1500 corresponding to the file 3000 based on the clock value 1400 of the storage system 1 and a difference value corresponding to the file 3000 of the clock difference information management table 1300. Herein, as shown in FIG. 3, since the difference value corresponding to the file 3000 is 0, the WORM clock control 110 provides the difference value between the clock value 1400 and 0 (i.e., the same value as the clock value 1400), as the WORM clock value 1500.

The migration request control 160 of the management server 11 requests the resource migration control 120 of the storage system 1 to perform migration processing of the file 3000. In this embodiment, the case where the management server 11 requests the storage system 1 to perform migration processing to the storage system 2 will be described. The request for the migration processing may be made with respect to the storage system 2 to be the migration destination of the file 3000, or may be made with respect to the storage system 3 that is neither a migration source nor a migration destination of the file 3000.

The resource migration control 1120 receiving a request for migration processing of the file 3000 determines whether or not requested migration processing is possible by use of the migration executing control 121 provided by the resource migration control 1120. The migration executing control 121 determines whether or not the migration processing is possible by use of each information such as the clock value 2400 of the storage system 2 at the migration destination, the WORM clock value 1500 of the storage system 1 at the migration source, the entry 220 of the file 3000, the entry 523 of the file 3000, and the like.

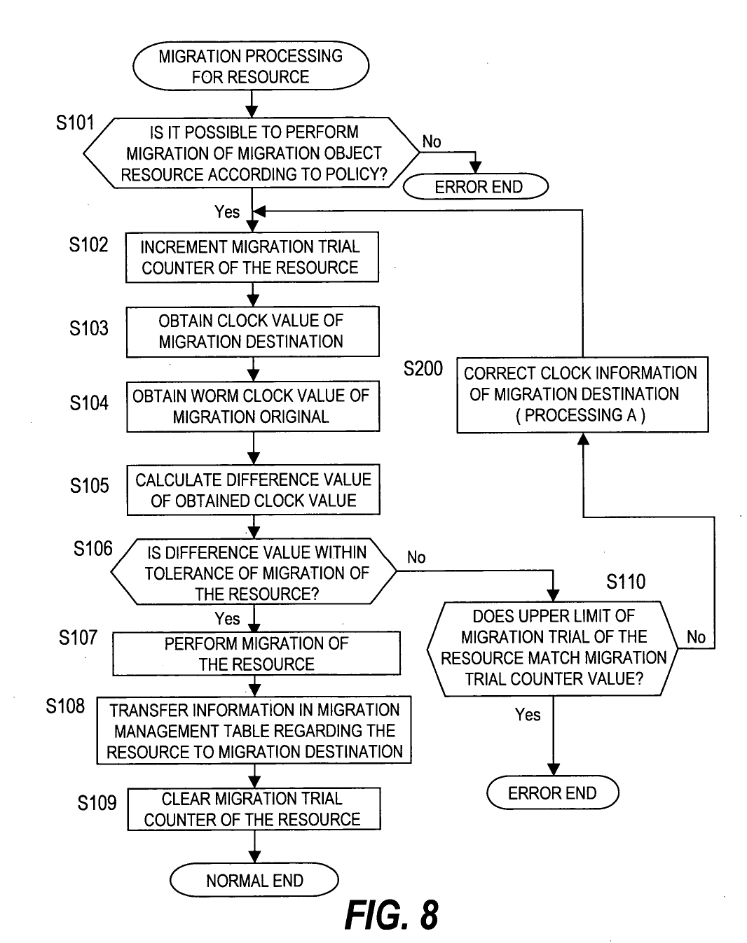

Hereinafter, the detailed processing procedure for determining whether or not migration processing is possible will be described with reference to FIG. 8.

FIG. 8 is a flow chart showing a procedure of migration processing for determining whether or not the migration processing of an information resource is possible in the migration executing control 121.

First, when the migration executing control 121 receives a migration request, the migration executing control 121 refers to the migration management table 1200, and obtains registered information with respect to the information resource specified as a migration object in an item of the migration flag of the entry 220. Then, it is determined whether or not the migration is possible from the contents of the obtained migration policy (S101).

In the case where a migration policy of the entry 220 is not set with respect to the information resource to be migrated in the migration management table 1200, and in the case where the information resource to be migrated is not present in the migration management table 1200, it is determined whether or not the migration is possible according to a standard set by a system separately. For example, in the case where the entry 220 is not set, a standard may be set so as to inhibit migration uniformly, or a system default policy may be set previously and applied.

As a result of determination in the step S101, in the case where the information resource to be migrated cannot be migrated, the process is ended as an error. In the case where the information resource to be migrated can be migrated, the process proceeds to the subsequent step S102.

Next, the migration executing control 121 increments a migration trial counter of the entry 230 of the information resource to be migrated in the migration management table 1200. More specifically, the migration executing control 121 adds 1 to the entry 230 (S102).

In the case where an entry of the information resource to be migrated is not present in the migration management table 1200, an entry of the information resource to be migrated is newly obtained, and the entry 203 may be incremented.

Next, the migration executing control 121 obtains a clock value 2400 of a storage system 2 at a migration destination by use of the clock information control 122 provided by the resource migration control 1120. The clock information control 122 obtains a clock value 2400 of the storage system 2 via the clock information control 122 in a resource migration control 2120 on the storage system 2 (S103). The clock information control 122 of the resource migration control 2120 requests the clock value control 102 of the storage system 2 to obtain the clock value 2400.

Next, the migration executing control 121 obtains a WORM clock value 1500 of the storage system 1 by use of the WORM clock control 110 of the migration source storage system 1 (S104).

The WORM clock control 110 obtains the WORM clock value 1500 corresponding to the information resource to be migrated. More specifically, the WORM clock control 110 calculates the WORM clock value 1500 corresponding to the information resource to be migrated, based on a difference value between the clock value 1400 obtained by the clock value control 102 and the object file 3000 obtained by the clock difference information management table 1300. The reason why the WORM clock value 1500 is obtained only with respect to the storage system 1 at a migration source is as follows: In the case where the information resource to be migrated on the storage system 1 at a migration source is the one migrated from another storage system previously, there is a possibility that clock difference information with respect to the information resource may have been registered in the clock difference information management table 1300.

Next, the migration executing control 121 calculates a difference value of the obtained two clock values (S105). The method of calculating a difference value to be used here is the one standardized in the system. For example, the WORM clock value 1500 at the migration source may be subtracted from the clock value 2400 at the migration destination, and vice versa.

Next, the migration executing control 121 determines whether or not the difference value is in a tolerance for migration of the information resource to be migrated by use of the calculated difference value and the entry 523 of the attributes 500 of the information resource to be migrated (S106). At this time, the migration executing control 121 obtains the entry 523 in the tolerance for migration of the information resource to be migrated via the tolerance control for migration 132 provided by the resource control 130 managing the information resource to be migrated.

In the case where the difference value is in the tolerance for migration, it is determined that the migration is possible, and the process proceeds to a step S107. On the other hand, in the case where the difference value is not in the tolerance for migration, it is determined that the migration is impossible, and the process proceeds to a step S110.

In the case where the entry 523 is not set in the information resource to be migrated, a standard set in the system separately is applied. For example, in the case where a tolerance for migration is not set, the migration may be inhibited uniformly, or it may be determined whether or not the migration is possible using a default tolerance value previously set in the system or a default tolerance value previously set in each information resource control.

In the step S106, in the case where it is determined that the migration is possible, the migration executing control 121 requests the migration control 133 provided by the resource control 130 of the information resource to be migrated to perform migration processing of the information resource. The migration control 133 having received the request performs the processing of migrating the information resource to be migrated to a specified destination (S107). More specifically, the migration control 133 transmits the information resource to be migrated to the storage system 2 at the migration destination via the network 10. In the storage system 2 at the migration destination, the migration control 133 stores the information resource transmitted from the storage system 1 at the migration source in a corresponding region of the disk drive 40 of the storage system. As a method of executing migration, other methods may be used.

The migration processing of other information resources (a file system 4000 and a volume 5000) is substantially the same as the migration processing contents of the file 3000. More specifically, in the case where the information resource to be migrated is a file, the migration control 133 transmits a file to be migrated to the storage system 2 at the migration destination. Furthermore, in the case where the information resource to be migrated is a file system, the migration control 133 transmits a file and file system management information contained in the file system to be migrated to the storage system 2 at the migration destination. Furthermore, in the case where the information resource to be migrated is a volume, the migration control 133 transmits data contained in the volume to be migrated to the storage system 2 at the migration destination.

When the migration processing of an information resource is completed by the processing in the step S107, the migration executing control 121 migrates information on the information resource to be migrated in the migration management table 1300 on the storage system 1 at the migration source to the migration management table 2200 in the storage system 2 at the migration destination (S108). Information to be migrated is all the information registered in an entry of the information resource to be migrated in the migration management table 1200.

Finally, the migration executing control 121 clears the value of the migration trial counter in the entry 230 of the information resource to be migrated in the migration management table 2200 in the storage system 2 at the migration destination (S109). More specifically, the migration executing control 121 clears the value of the entry 230 via the migration executing control 121 of the storage system 2 at the migration destination. When this processing is completed, the migration processing of an information resource is ended normally.

On the other hand, in the step S106, in the case where it is determined that the migration is impossible, the migration executing control 121 compares the value of an upper limit of migration trial of the entry 230 registered in the entry of the information resource in the migration management table 1200, with the value of the migration trial counter of the current entry 230. As a result of the comparison, in the case where the value of the entry 223 is matched with the value of the current migration trial counter 230, it is determined that the migration is impossible, and the migration processing is ended as an error.

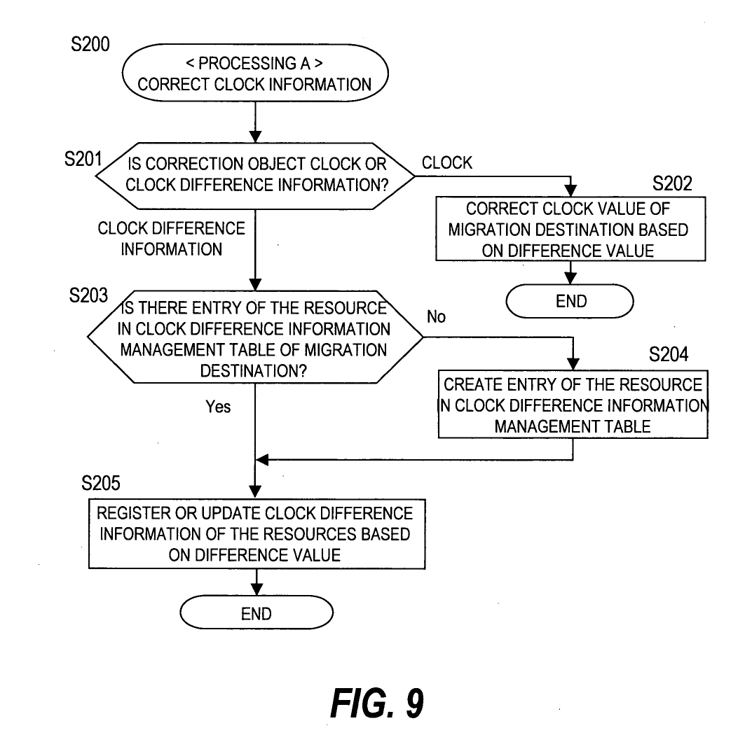

On the other hand, as a result of the comparison, in the case where the value of the entry 223 is not matched with the value of the current entry 230, the migration executing control 121 executes correction processing (processing A) of clock information in the storage system 2 at the migration destination (S200). This correction processing will be described in FIG. 9.

Next, the correction processing (processing A) of clock information during migration will be described.

FIG. 9 is a flow chart showing a procedure of processing of correcting clock information during migration processing of an information resource in the migration executing control 121.

First, the migration executing control 121 obtains information on the entry 222 to be corrected, registered in the entry of the information resource to be migrated in the migration management table 1200. Then, it is determined whether the entry 222 is set at a clock or at clock difference information (S201). In the case where the entry 222 is set at a clock, the process proceeds to the step S202, and in the case where the entry 222 is set at clock difference information, the process proceeds to the step S203.

In the step S201, in the case where it is determined that the entry 222 is set at a clock, the migration executing control 121 corrects the clock value 2400 of the storage system 2 at the migration destination. More specifically, the migration executing control 121 requests the clock value control 102 provided by the clock control 100 of the storage system 2 at the migration destination to update the clock value 2400 via the clock information control 122 provided by the information resource migration control 120. The update value is a difference value of a clock calculated by the migration executing control 121 in the step S105 in FIG. 8. More specifically, the clock value 2400 of the storage system 2 at the migration destination is corrected so as to be matched with the WORM clock value 1500 of the information resource to be migrated in the storage system 1 at the migration source. When the correction of the clock value 2400 of the storage system 2 at the migration destination is completed, the clock correction processing is ended.

On the other hand, in the step S201, in the case where it is determined that the entry 222 is set at clock correction information, the migration executing control 121 registers correction information in the clock difference information management table 2300 of the storage system 2 at the migration destination. More specifically, the following processing is performed.

First, prior to the registration, the migration executing control 121 requests the clock difference information management table 2300 in the storage system 2 at the migration destination to confirm whether or not there is an entry corresponding to a resource to be migrated (S203). As a result of the confirmation, in the case where there is no entry corresponding to the information resource to be migrated, the process proceeds to the step S204. In the case where there is an entry corresponding to the information resource to be migrated, the process proceeds to the step S205.

In the step S203, in the case where there is no entry of the information resource to be migrated in the clock difference information management table 2300, the migration executing control 121 newly creates an entry for the information resource, and requests the clock difference information management 124 of the storage system 2 at the migration destination to initialize a region of the created entry (S204). The entry creation processing may be requested so that the same processing is performed in the case where there is no entry, at the same time when the request for the confirmation of the presence/absence of an entry in the step S203 is requested. When an entry is created, the process proceeds to the step S205.

On the other hand, in the step S203, in the case where there is an entry of the information resource to be migrated in the clock difference information management table 2300, the migration executing control 121 requests the migration destination storage system 2 to register a difference value in the difference information 320 of the entry 320. In the case where the difference value has already been registered in the entry 320, the migration destination storage system 2 discards the set value, and updates it to a new value. The registration of the difference value is requested at the same time when the confirmation of the presence/absence of an entry in the step S203 is requested. In the case where it is determined that there no entry, an entry is newly created (S204), and the difference information is registered in the created new entry.

Next, the migration executing control 121 registers or updates the clock difference information based on the difference value of the clock difference information management table 2300 registered in the migration destination storage system 2 (S205). When the processing is completed, the clock correction processing is ended.

By the above-mentioned processing, migration processing between storage systems is executed.

Next, the processing of confirming a retention term expiration of a WORM resource will be described.

Regarding the WORM resource, a retention term is set as described above, and the processing of determining whether or not the retention term has expired is necessary. The storage system 1 checks the retention term of the WORM resource managed by the storage system 1, based on a request from the management server 11. Then, the storage system 1 determines whether or not the retention term of the WORM resource has expired. The WORM resource whose retention term has expired may be deleted, or may be stored as an ordinary information resource after canceling the WORM attributes.

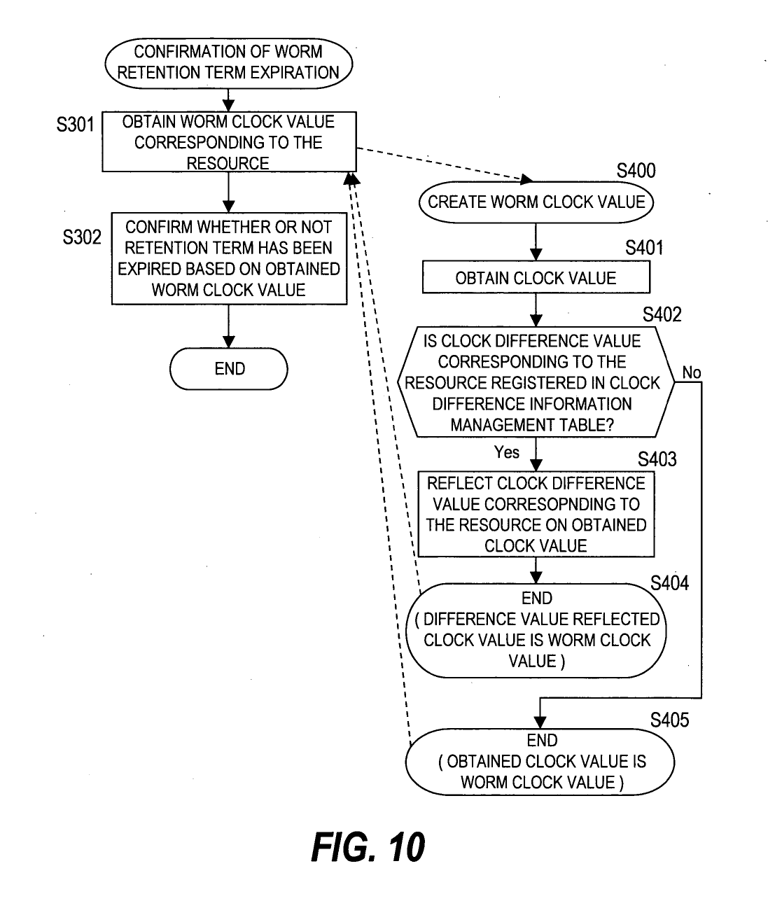

FIG. 10 is a flow chart showing a procedure of the processing of confirming the retention term of a WORM resource in the resource control 130. Herein, an example of the processing of confirming the retention term expiration in the storage system 1 will be shown.

First, the resource control 130 requests the WORM clock control 110 to obtain a WORM clock value 1500 corresponding to the WORM resource (S301). The WORM clock control 110 executes the processing of creating the WORM clock value 1500 with respect to the request for obtaining the WORM clock value 1500 (S400). A procedure of the processing of creating the WORM clock value 1500 will be described later.

The resource control 130 obtains the WORM clock value 1500 from the WORM clock control 110, and thereafter, confirms whether or not the retention term of the WORM resource has expired by use of the obtained WORM clock value 1500 and the WORM retention term of the entry 522 set in the WORM resource (S302). The resource control 130 returns the results of the confirmation, i.e., whether or not the retention term has expired, to a request source.

Next, the processing of creating the WORM clock value 1500 will be described.

In the case where the resource control 130 requests the creation of the WORM clock value 1500 in the step S301, the WORM clock control 110 executes the processing of creating the WORM clock value 1500 corresponding to a WORM resource object (S400).

First, the WORM clock control 110 requests the clock value control 101 for the clock value 1400 at a current time (S401).

Next, the WORM clock control 110 requests the clock information control 122 provided by the resource migration control 120 to confirm whether or not difference information of the entry 320 corresponding to the WORM resource object in the clock difference information management table 1300 is registered (S402). When receiving a confirmation request, the clock information control 122 confirms whether or not there is an entry corresponding to the WORM resource object. If there is the entry, the clock information control 122 returns the value of the entry 320 registered in the entry. If there is no entry, the clock information control 122 returns the result to the effect that there is no entry. The WORM clock control 110 determines a return value from the clock information control 122. In the case where the return value is an entry, the process proceeds to the step S403. In the case where the return value is the absence of an entry, the WORM clock control 110 returns the clock value 1400 that has already been obtained to a request source as the WORM clock value 1500 (S405).

In the case where there is the corresponding entry in the clock difference information management table 1300 in the step S402, the WORM clock control 110 obtains the entry 320 registered in that entry. Then, the WORM clock control 110 reflects the value of the entry 320 onto the clock value 1400 that has already been obtained (S403). Specifically, the WORM clock control 110 reflects difference information by a method separately determined for the system. For example, the WORM clock control 110 adds the value of the difference information 320 to the clock value 1400, thereby reflecting the difference information.

The WORM clock control 110 returns, to the request source as the WORM clock value 1500, the clock value 1400 to which the value of the entry 320 is reflected (S404).

In the processing of confirming a retention term expiration described in FIG. 10, only whether or not the WORM retention term of the entry 522 has expired is confirmed. At this time, the invalidation of the entry 521 that is the WORM attributes of the WORM resource object, the deletion of the WORM resource object, the extension of the entry 522 of the WORM resource object, and the like may be performed simultaneously.

Next, the processing of setting a migration policy will be described.

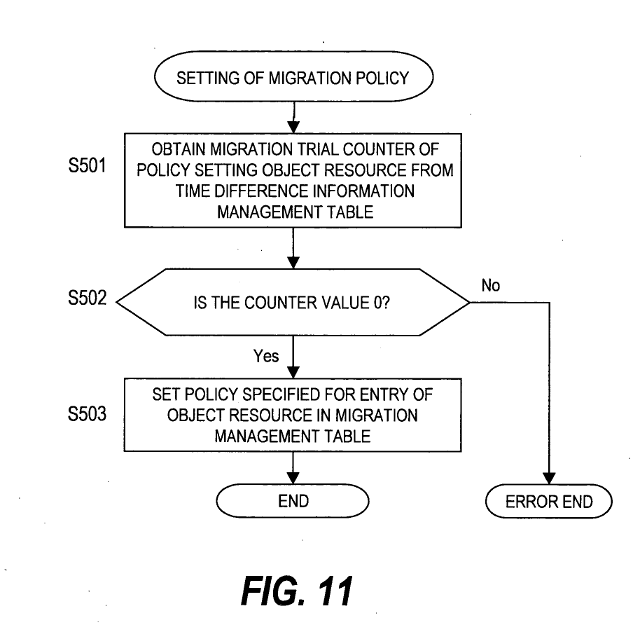

FIG. 11 is a flow chart showing a procedure of migration policy setting processing of an information resource.

The setting of a migration policy with respect to an information resource is previously requested from the management server 11 by an administrator, for example. The migration policy setting control 140 receives the request, and requests the resource migration control 120 of the storage system in which an information resource to be set is present to set a migration policy.

The resource migration control 120 having received the request for setting a migration policy obtains a migration trial counter of the entry 230 from an entry corresponding to the information resource to be set for a migration policy from the migration management table 200 via the migration management 123 (S501).

Next, the resource migration control 120 confirms whether or not the value of the obtained entry 230 is 0 (S502). In the case where the value of the entry 230 is not 0, the resource migration control 120 determines that the information resource is being migrated, and ends the processing of setting a migration policy with respect to the information resource as an error. The reason why state of the processing of setting a migration policy makes error during the migration processing is to prevent the occurrence of inconsistency in the migration processing as a result of the change of a migration policy during migration.

In the case where the value of the entry 230 is 0 in the step S502, the resource migration control 120 sets each value of the entries 221, 222, and 223 in the entry 220 for the migration corresponding to the information resource (S503). More specifically, the resource migration control 120 sets a migration policy of the information resource. In the case where there is no entry corresponding to the information resource, an entry is newly created, and a migration policy is set in the newly created entry.

When the setting of a migration policy is completed, the resource migration control 120 notifies the migration policy setting control 140 that is a request source of the completion of the setting, and ends the processing.

Next, processing of setting a tolerance for migration will be described.

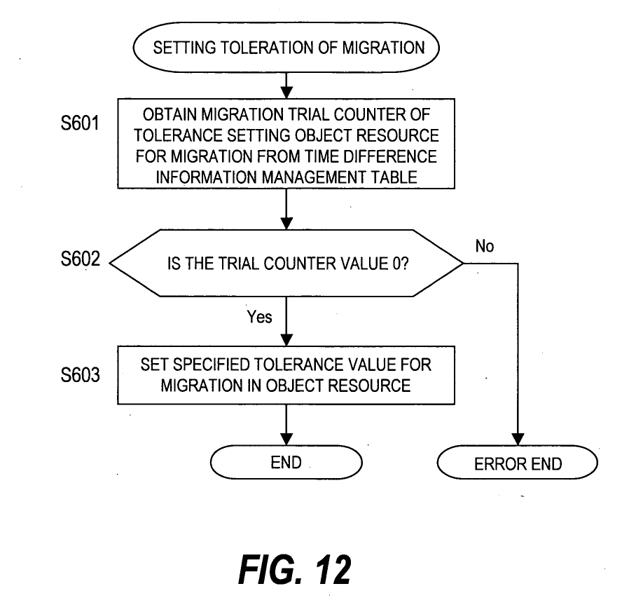

FIG. 12 is a flow chart showing a processing procedure in tolerance setting processing for migration of an information resource.

The tolerance setting control for migration 150 requests the resource control 130 of the storage system in which an information resource to be set is present to set a tolerance for migration. The tolerance for migration is previously set, as described above, before the migration processing is performed, in view of the WORM retention term of an information resource, the precision of a clock of a storage system storing the information resource, and the like.

The resource control 130 having received a request for setting a tolerance for migration requests the resource migration control 120 to refer to the migration management table 200 to obtain the value of the entry 230 corresponding to the information resource to be set (S601). The resource migration control 120 obtains the value of the entry 230 via the migration management 123.

The resource control 130 confirms whether or not the value of the obtained entry 230 is 0 (S602).

In the case where the value of the entry 230 is not 0, the resource control 130 determines that the information resource is being migrated, and ends the processing of setting a tolerance with respect to the information resource as an error. The reason why the processing of setting a tolerance is ended as an error during the migration processing is to prevent the occurrence of inconsistency in the migration processing by the change in a tolerance for migration during the migration.

In the case where the value of the entry 230 is 0 in the step S602, the resource control 130 sets a tolerance for migration with respect to the information resource (S603). More specifically, a tolerance for migration is set in the entry 523 of the entry 520 that is extended attributes of the attributes 500 corresponding to the information resource.

When the setting is completed, the migration policy setting control 150 that is a request source is notified of the completion of the setting, and the processing is ended.

It should be appreciated that this invention is not limited to this embodiment, and can have various configurations without departing from its spirit. For example, there are modified examples as described below.

### MODIFIED EXAMPLE 1

In this embodiment, a difference value of a clock is registered in the difference information of the entry 320 in the clock difference information management table 300. In contrast, the information registered as the entry 320 may be any information as long as it is capable of calculating a WORM clock value corresponding to the information resource. For example, as the entry 320, an update log of a clock difference value is recorded. By recording an update log, it is possible to grasp the information regarding when difference information of a clock is registered, and how much the clock value is corrected at that time.

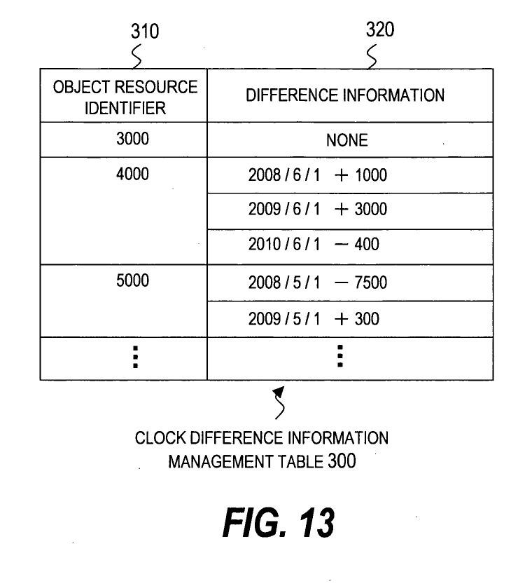

FIG. 13 is an explanatory diagram illustrating an example configuration of the clock difference information management table 300, showing a configuration in the case where an update log is recorded in difference information of the entry 320.

As described above, the clock difference information management table 300 contains a resource identifier object of the entry 310 and difference information of the entry 320.

In the difference information of the entry 320, at a time of migration of the information resource, an update log of clock information in a storage system at a migration source and a storage system at a migration destination are recorded successively. The update log contains information on the date and time of the update and information on the updated difference value.

In the migration processing, the resource migration control 120 uses the clock information control 122 when correcting a clock, and registers difference information of clock information between storage systems in the clock difference information management table 300 of the storage system at the migration destination as an update log. As the unit of the value to be registered as the update log, the one determined for the system is applied as described above. Furthermore, as the meaning of positive and negative of the value, the one determined for the system is applied similarly.

Furthermore, as described above, when the information resource is used in which difference information in an update log format is registered in the clock difference information management table 300, the update log is used to correct clock information.

As shown in FIG. 13, for example, in the information resource of an entry whose resource identifier is 4000, three update logs are set as difference information. When the information resource 4000 is dealt with, in the case where clock information is used, the clock information of the storage system is corrected with a last updated log among the updated logs, and the corrected clock information value is used. Particularly, in the case of dealing with a WORM resource, the WORM clock control 110 performs correction processing using the last updated log among the updated logs. The detailed procedure of correction processing is the same as the procedure of correction processing described in FIG. 9.

### MODIFIED EXAMPLE 2

In this embodiment, in the resource migration control 120, in the case where the migration of the information resource is permitted, more specifically, in the case where the difference value of a clock value is in a tolerance for migration, the clock information of the storage system 2 at a migration destination is not corrected. In contrast, in this example, even in the case where the migration is permitted, clock information may be corrected in the storage system 2 at the migration destination.

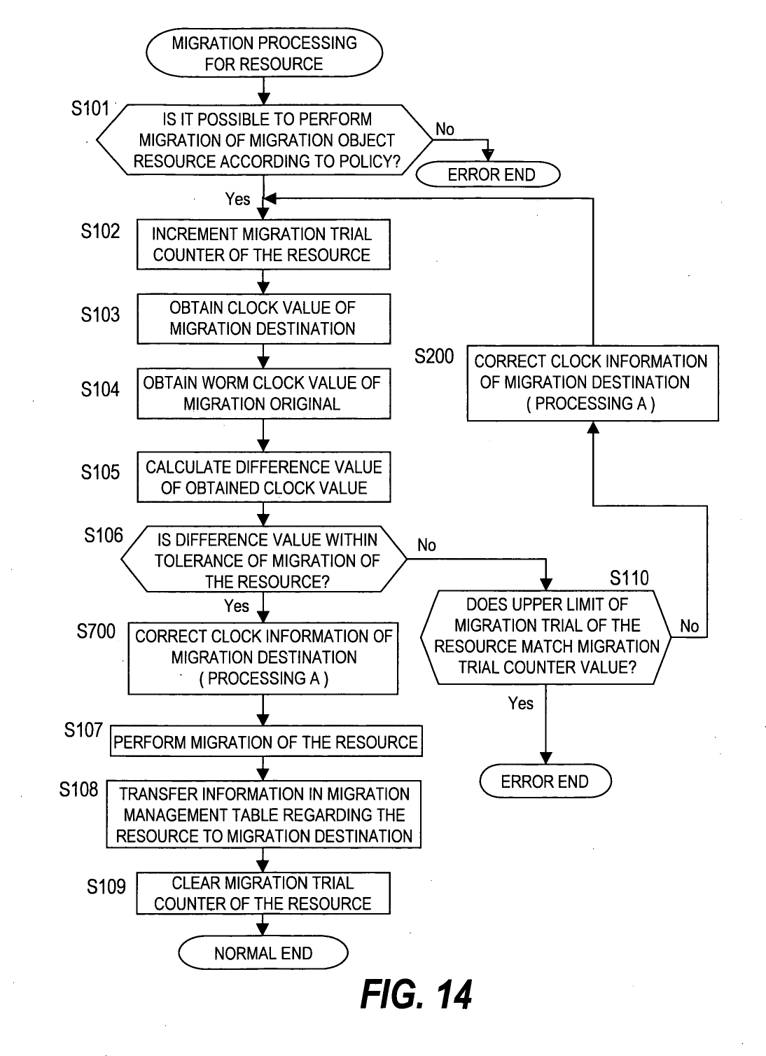

FIG. 14 is a flow chart showing a procedure of the migration processing of an information resource in the migration executing control 121, and also showing the procedure of the processing in the case of correcting clock information even when the migration is permitted.

The flow chart of FIG. 14 is substantially the same as that of FIG. 8, except for the processing of correcting clock information of the storage system 2 at the migration destination after the migration is permitted.

More specifically, in the step S106, in the case where a difference value is in a tolerance for migration, the migration executing control 121 executes the correction processing (processing A) of clock information of the storage system 2 at the migration destination before the step S107 (S700). The processing is the same as the processing A (S200) described in FIG. 9. When the processing of correcting clock information is completed, the migration executing control 121 proceeds to the step S107, and executes the migration processing of the information resource. The subsequent processing is similar to that described in FIG. 8.

### MODIFIED EXAMPLE 3

In this embodiment, when the clock value managed by the clock control 100 is updated, the clock value is directly updated, whereby the clock value is updated. In contrast, in the clock control 100, an update log when updating the clock value may be managed separately.

More specifically, in the case where the clock control 100 manages an update log, the update log may be managed separately under the condition that the clock value managed by the clock control 100 is directly updated. Alternatively, only the update log is managed separately without updating the clock value, and the clock value on which the information of the update log is reflected may be provided, if required. By allowing the clock control 100 to manage the update log, it is possible to know when and how the clock value is updated.

The update log of the clock value may be managed by another control instead of the clock control 100. For example, a program or the like for managing a log may be prepared separately, and the update log of the clock value may be managed by the program.

### MODIFIED EXAMPLE 4

This embodiment supposes that the resource migration control 120 and the WORM clock control 110 are present on a storage system. In contrast, the resource migration control 120 may be present on the management server 11 or another server. Furthermore, the WORM clock control 110 may be present on the management server 11 or another server. Furthermore, the resource migration control 120 and the WORM clock control 110 may be present respectively on separate storage systems or servers. Furthermore, the migration management table 200 and the clock difference information management table 300 provided by the resource migration control 120 may be respectively present on separate storage systems or servers.

### MODIFIED EXAMPLE 5

This embodiment supposes that the tolerance control for migration 132 of each information resource is provided by the resource control 130. In contrast, for example, the following configuration may be possible: the tolerance control for migration 132 is separated from the resource control 130, and the tolerance control for migration 132 may be provided separately in the management server 11 or another server.

### MODIFIED EXAMPLE 6

This embodiment supposes that the clock difference information management table 300 of each information resource is provided in the clock difference information management 124 in the resource migration control 120. This invention is not limited thereto. For example, the following configuration may be possible: the clock information management 124 is separated from the resource migration control 120, and the resource control 130 manages the clock difference information management table 300 regarding the information resource.

In the case where the clock difference information management table 300 is managed in the resource control 130, in the migration processing of the information resource, the migration executing control 121 migrates the clock difference information management table of the information resource to a storage system at a migration destination by the migration control 133 provided by the resource control 130. Therefore, in the same way as in this embodiment, the clock difference information of the information resource can be taken over by the storage system at the migration destination.

### MODIFIED EXAMPLE 7

In this embodiment, in the migration processing of an information resource, the clock information is corrected. In contrast, for example, the clock information may be corrected with respect to the replication processing, backup/restore processing of the information resource, and the like.

In the case of correcting the clock information in the replication processing, a program or the like for executing the replication processing includes a resource replication control for providing the processing equal to that of the resource migration control 120. Furthermore, in the case of correcting the clock information in the backup/restore processing, a program or the like for executing the backup/restore processing includes a resource backup/restore control for providing the processing equal to that of the resource migration control 120.

### MODIFIED EXAMPLE 8

In this embodiment, any migration processing method of an information resource can be used. In this modified example, the following migration processing system will be described.

A case will be considered, in which the WORM retention term of the entry 522 is managed in a term format such as the number of days in the WORM control 131 provided by the resource control 130. Herein, in the migration control 133 provided by the resource control 130, when the WORM resource to be migrated is migrated, the WORM retention term information of the WORM resource is recalculated to a remaining retention term value by setting the migration processing as a time of basis, and the remaining retention term value is updated as a new WORM retention term.

For example, a case will be considered in which, regarding a WORM resource whose WORM attributes are made effective with a WORM retention term being specified as 1000 days, the WORM resource is migrated when 200 days elapses after the WORM attributes of the WORM resource are made effective. In this embodiment, the entry 522 of the resource is migrated to the storage system at the migration destination as time information at a time when the WORM attributes of the WORM resource are made effective, and information on a term.

On the other hand, according to this method, in the entry 522 of the WORM resource in the storage system at the migration destination, time information at a time when the WORM resource is migrated to the storage system is set as a new base of a term. Furthermore, the resource migration control 120 calculates a remaining WORM retention term of the WORM resource at a time of the migration, and sets the calculated remaining WORM retention term as a new term of the WORM resource in the storage system at the migration destination. More specifically, 800 days obtained by subtracting 200 days that have already elapsed, from 1000 days corresponding to a WORM retention term, are specified as a WORM retention term.

Thus, the entry 522 of a WORM resource to be migrated is updated to new information at a migration processing time. Therefore, there is an advantage that it is not necessary to correct clock information of a storage system at a migration destination.

It is necessary to perform a calculation method in which the WORM retention term of the entry 522 of the WORM resource to be migrated is neither extended nor shortened. More specifically, it is necessary to calculate, appropriately using correction values of the WORM retention term, elapsed time, and clock information so that the expiration period of the original WORM retention term is not changed. Furthermore, in the case of updating the entry 522 of the WORM resource to be migrated according to this method, the originally set entry 522 may be overwritten, or a region for updating is prepared separately and the updated information may be stored therein.

This method has been described by exemplifying the migration processing of a resource. However, this invention is not limited thereto. For example, the present method may be applied to the replication processing and backup/restore processing of the information resource.

In the case where the replication processing is targeted, in the replication processing, a remaining WORM retention term at the processing time is calculated and set to be a WORM retention term in the storage system at the replication destination. Furthermore, in the case where the backup processing is targeted, at a time of the backup processing, a remaining WORM retention term at the processing time is calculated and set to be a WORM retention term at the backup destination. Furthermore, in the case where the restore processing is targeted, at a time of the restore processing, a remaining WORM retention term at the processing time is calculated and set to be a WORM retention term in the storage system at the restore destination.

This invention can be realized in various modes, such as a program for realizing the above-mentioned storage system, a recording medium storing the program, and a data signal containing the program and embodied in a carrier wave.

In the case where this invention is configured as a computer program, this invention may be configured as a storage system, an entire program controlling the storage system, or only a portion executing the processing by this invention. Furthermore, examples of a recording medium include: a flexible disk; a CD-ROM; a DVD-ROM; a punch card; a printed matter on which a bar code is printed; and various volatile recording media or non-volatile recording media which can be read by a computer through an internal disk drive built therein or an external disk drive connected thereto.

While the present invention has been described in detail and pictorially in the accompanying drawings, the present invention is not limited to such detail but covers various obvious modifications and equivalent arrangements, which fall within the purview of the appended claims.

What is claimed is:

1. A storage system, comprising:
a control module;
a disk drive for storing data; and
a time information module for managing time information including a time,
wherein the control module:
obtains first time information from another storage system connected via a network;
obtains second time information from the time information module;
calculates a difference value between the first time information and the second time information; and
in a case where the calculated difference value is smaller than a predetermined threshold, moves the data stored in the disk drive to the another storage system.

2. The storage system according to claim 1, wherein the control module inhibits an update and a deletion of at least one piece of the data stored in the disk drive during a specified term.

3. The storage system according to claim 1, wherein the threshold is previously determined for each of the data stored in the disk drive.

4. The storage system according to claim 1, further comprising a memory module storing, for each of the data, at least one of information on whether or not the data can be moved, information on a method of correcting information on a time of the another storage system, and information on a tolerance number of failures of processing of moving the data,
wherein the control module determines whether or not the data stored in the disk drive is to be moved to the another storage system, based on the information stored in the memory module.

5. The storage system according to claim 1, wherein the control module:
in a case where the calculated difference value is larger than the previously determined threshold value, corrects third time information of the another storage system to make the third time information substantially the same as the second time information;
obtains the corrected third time information from the another storage system;
calculates a difference value between the third time information and the second time information; and
in a case where the calculated difference value is smaller than a predetermined threshold, moves the data stored in the disk drive to the another storage system.

6. The storage system according to claim 1, wherein:
the time information module manages time information for each of the data stored in the disk drive; and
the control module obtains the first time information for each of the data stored in the another storage system from the another storage system, and obtains the second time information for each of the data stored in the disk drive from the time information module.

7. The storage system according to claim 6, wherein the control module:
when moving the data stored in the disk drive to the another storage system, obtains the first time information from the another storage system;
obtains the second time information corresponding to the data to be moved from the time information module;
calculates a difference value between the first time information and the second time information;
in a case where the calculated difference value is larger than a predetermined threshold corresponding to the data to be moved, corrects the third time information of the another storage system to make the third time information substantially the same as the second time information;
obtains the corrected third time information from the another storage system;
calculates a difference value between the third time information and the second time information; and
in a case where the calculated difference value is smaller than a predetermined threshold corresponding to the data to be moved, moves the data stored in the disk drive to the another storage system.

8. The storage system according to claim 7, wherein, in a case where the calculated difference value is larger than a predetermined threshold, the control module corrects the third time information of the another storage system to make the third time information substantially the same as the second time information by using a relative value with the first time information.

9. The storage system according to claim 8, wherein, in a case where the time is corrected by the another storage system, the time information module accumulates to store information on the correction.

10. A data migration method for a storage system that includes a control module, a disk drive for storing data, and a time information module for managing time information indicating a time, the method comprising:
obtaining first time information from another storage system connected via a network;
obtaining second time information from the time information module;
calculating a difference value between the first time information and the second time information; and
in a case where the calculated difference value is smaller than a predetermined threshold, moving the data stored in the disk drive to the another storage system.

11. The data migration method according to claim 10, further comprising inhibiting an update and a deletion of at least one piece of data stored in the disk drive during a specified term.

12. The data migration method according to claim 10, further comprising previously determining the threshold value for each of the data stored in the disk drive.

13. The data migration method according to claim 10, further comprising:
storing in a memory module, for each of the data, at least one of information on whether or not the data can be moved, information on a method of correcting information on a time of the another storage system, and information on a tolerance number of failures of processing of moving the data; and
determining whether or not the data stored in the disk drive is to be moved to the another storage system, based on the information stored in the memory module.

14. The data migration method according to claim 10, further comprising:
in a case where the calculated difference value is larger than the predetermined threshold, correcting third time information of the another storage system to make the third time information substantially the same as the second time information;
obtaining the corrected third time information from the another storage system;
calculating a difference value between the third time information and the second time information; and
in a case where the calculated difference value is smaller than a predetermined threshold, moving the data stored in the disk drive to the another storage system.

15. The data migration method according to claim 10, further comprising:
managing, in the time information module, a time information for each of the data stored in the disk drive; and
obtaining the first time information for each of the data stored in the another storage system from the another storage system, and obtains the second time information for each of the data stored in the disk drive from the time information module.

16. The data migration method according to claim 15, further comprising:
when moving the data stored in the disk drive to the another storage system, obtaining the first time information from the another storage system;
obtaining the second time information corresponding to the data to be moved from the time information module;
calculating a difference value between the first time information and the second time information;
in a case where the calculated difference value is larger than a predetermined threshold corresponding to the data to be moved, correcting third time information of the another storage system to make the third time information substantially the same as the second time information;
obtaining the corrected third time information from the another storage system;
calculating a difference value between the third time information and the second time information; and
in a case where the calculated difference value is smaller than a predetermined threshold corresponding to the data to be moved, moving the data stored in the disk drive to the another storage system.

17. The data migration method according to claim 16, further comprising, in a case where the calculated difference value is larger than a predetermined threshold, correcting the third time information of the another storage system to make the third time information substantially the same as the second time information by using a relative value with the first time information.

18. The data migration method according to claim 17, further comprising, in a case where the time is corrected by the another storage system, accumulating to store information on the correction.
